(19) United States
(12) Patent Application Publication
(10) Pub. No.: US 2009/0108479 A1
(43) Pub. Date: Apr. 30, 2009

(54) Method for Making Biomedical Devices

(75) Inventors: Yu-Chin Lai, Pittsford, NY (US); Weihong Lang, Amston, CT (US)

Correspondence Address: Bausch & Lomb Incorporated, One Bausch & Lomb Place, Rochester, NY, 14604-2701, US

(73) Assignee: Bausch & Lomb Incorporated, Rochester, NY (US)

(21) Appl. No.: 11/924,736

(22) Filed: Oct. 26, 2007

(51) Int. Cl. B29D 11/00

(52) U.S. Cl. 264/2.6

(57) ABSTRACT

A method of preparing a biomedical device is disclosed. The method involves the steps: (a) cast molding at least one biomedical device formed from a monomer mixture comprising at least one silicone-containing monomer and at least one hydrophilic monomer in a mold assembly, the mold assembly comprising at least one anterior mold part made of a first plastic material and one posterior mold part made of a second plastic material, wherein the first plastic material is more polar relative to the second plastic material; and (b) contacting a surface of the biomedical device with a solution comprising a proton-donating wetting agent, whereby the wetting agent forms a complex with the hydrophilic monomer on the surface of the biomedical device.

### BACKGROUND OF THE INVENTION

1. Technical Field

The present invention generally relates to a method of making biomedical devices such as contact lenses, intraocular lenses, and other ophthalmic devices.

2. Description of the Related Art

Medical devices such as ophthalmic lenses made from silicone-containing materials have been investigated for a number of years. Such materials can generally be subdivided into two major classes, namely hydrogels and non-hydrogels. Non-hydrogels do not absorb appreciable amounts of water, whereas hydrogels can absorb and retain water in an equilibrium state. Regardless of their water content, both non-hydrogel and hydrogel silicone medical devices tend to have relatively hydrophobic, non-wettable surfaces that have a high affinity for lipids. This problem is of particular concern with contact lenses.

An advantage of silicone hydrogels over non-silicone hydrogels is that silicone hydrogels typically have higher oxygen permeability due to the inclusion of the silicone-containing monomer. Oxygen permeability is a desirable property for many biomedical devices; for example, in the case of contact lenses, the human cornea will be damaged if it is deprived of adequate oxygen for an extended period.

Those skilled in the art have long recognized the need for modifying the surface of such silicone contact lenses so that they are compatible with the eye. It is known that increased hydrophilicity of the contact lens surface improves the wettability of the contact lenses. This, in turn, is associated with improved wear comfort of contact lenses. Additionally, the surface of the lens can affect the lens's susceptibility to deposition, particularly the deposition of proteins and lipids from the tear fluid during lens wear. Accumulated deposition can cause eye discomfort or even inflammation. In the case of extended wear lenses (i.e., lenses used without daily removal of the lens before sleep), the surface is especially important, since extended wear lens must be designed for high standards of comfort and biocompatibility over an extended period of time.

For example, U.S. Pat. No. 6,428,839 discloses a method for improving the wettability of a medical device involving (a) providing a medical device formed from a monomer mixture comprising a silicone-containing monomer and a hydrophilic monomer, wherein the medical device has not been subjected to a surface oxidation treatment; and (b) contacting a surface of the medical device with a wetting agent solution comprising at least one proton-donating wetting agent selected from the group consisting of P(vinylpyrolidinone(VP)-co-acrylic acid(AA)), P(methylvinylether-alt-maleic acid), P(acrylic acid-graft-ethyleneoxide), P(acrylic acid-co-methacrylic acid), P(acrylamide-co-AA), P(acrylamide-co-AA), P(AA-co-maleic), and P(butadiene-maleic acid), whereby the wetting agent forms a complex with the hydrophilic monomer on the surface of the medical device in the absence of a surface oxidation treatment step and without the addition of a coupling agent.

It would be desirable to provide an improved method for making biomedical devices such as silicone hydrogel contact lens that is simple, cost effective and results in an optically clear, hydrophilic surface film. It is also desirable that the hydrophilic surface film not only exhibit improved wettability, but generally allow the use of a silicone hydrogel contact lens in the human eye for extended period of time. In the case of a silicone hydrogel lens for extended wear, it would be desirable to provide a contact lens with a surface that is also highly permeable to oxygen and water. Such a surface treated lens would be comfortable to wear in actual use and may allow for the extended wear of the lens without irritation or other adverse effects to the cornea. It would further be desirable to manufacture such a surface treated lens without the need for an oxidation step such as plasma treatment or corona discharge treatment.

### SUMMARY OF THE INVENTION

In accordance with one embodiment of the present invention, a method of preparing a biomedical device for use in or on the eye is provided, the method comprising the steps of: (a) cast molding at least one biomedical device formed from a monomer mixture comprising at least one silicone-containing monomer and at least one hydrophilic monomer in a mold assembly, the mold assembly comprising at least one anterior mold part made of a first plastic material and one posterior mold part made of a second plastic material, wherein the first plastic material is more polar relative to the second plastic material; and (b) contacting a surface of the biomedical device with a solution comprising a proton-donating wetting agent, whereby the wetting agent forms a complex with the hydrophilic monomer on the surface of the biomedical device.

In accordance with a second embodiment of the present invention, a method of preparing a biomedical device for use in or on the eye is provided, the method comprising the steps of: (a) cast molding at least one biomedical device formed from a monomer mixture comprising at least one silicone-containing monomer and at least one hydrophilic monomer in a mold assembly, the mold assembly comprising at least one anterior mold part made of a first plastic material and one posterior mold part made of a second plastic material, wherein the first plastic material is more polar relative to the second plastic material; (b) removing the biomedical device from the mold assembly; and (c) contacting a surface of the biomedical device with a solution comprising a proton-donating wetting agent, whereby the wetting agent forms a complex with the hydrophilic monomer on the surface of the biomedical device.

In accordance with a third embodiment of the present invention, a method for improving the wettability of a biomedical device is provided, the method comprising the steps of: (a) cast molding at least one biomedical device formed from a monomer mixture comprising at least one silicone-containing monomer and at least one hydrophilic monomer in a mold assembly, the mold assembly comprising at least one anterior mold part made of a first plastic material and one posterior mold part made of a second plastic material, wherein the first plastic material is more polar relative to the second plastic material; and (b) contacting a surface of the biomedical device with a solution comprising a proton-donating wetting agent, whereby the wetting agent forms a complex with the hydrophilic monomer on the surface of the biomedical device.

In accordance with a fourth embodiment of the present invention, a method for improving the wettability of a biomedical device is provided, the method comprising the steps of: (a) cast molding at least one biomedical device formed from a monomer mixture comprising at least one silicone-containing monomer and at least one hydrophilic monomer in a mold assembly, the mold assembly comprising at least one anterior mold part made of a first plastic material and one posterior mold part made of a second plastic material, wherein the first plastic material is more polar relative to the second plastic material; (b) removing the biomedical device from the mold assembly; and (c) contacting a surface of the biomedical device with a solution comprising a proton-donating wetting agent, whereby the wetting agent forms a complex with the hydrophilic monomer on the surface of the biomedical device.

### BRIEF DESCRIPTION OF THE DRAWINGS

FIG. 1 is a schematic exploded view of a representative mold assembly according to an embodiment of the present invention.

FIG. 2 is a schematic cross-sectional view of the mold assembly of FIG. 1 assembled for cast molding a biomedical device.

### DETAILED DESCRIPTION OF THE PREFERRED EMBODIMENTS

The present invention is directed to a method of making biomedical devices. In general, the method involves at least the steps of (a) cast molding at least one biomedical device formed from a monomer mixture comprising at least one silicone-containing monomer and at least one hydrophilic monomer in a mold assembly, the mold assembly comprising at least one anterior mold part made of a first plastic material and one posterior mold part made of a second plastic material, wherein the first plastic material is more polar relative to the second plastic material; and (b) contacting a surface of the biomedical device with a solution comprising a proton-donating wetting agent, whereby the wetting agent forms a complex with the hydrophilic monomer on the surface of the biomedical device.

In one embodiment, the method of the present invention advantageously requires neither a surface oxidation treatment step nor the addition of a coupling agent. The term “coupling agent” means an entity other than the medical device or the hydrophilic coating material that forms a linkage between the surface of the medical device and the hydrophilic coating material. Examples of linkages provided by coupling agents include ester linkages and amide linkages.

As used herein, a “biomedical device” is any article that is designed to be used while either in or on mammalian tissues or fluid, and preferably in or on human tissue or fluids. Representative examples of biomedical devices include, but are not limited to, artificial ureters, diaphragms, intrauterine devices, heart valves, catheters, denture liners, prosthetic devices, ophthalmic lens applications, where the lens is intended for direct placement in or on the eye, such as, for example, intraocular devices and contact lenses. The preferred biomedical devices are ophthalmic devices, particularly contact lenses, most particularly contact lenses made from silicone hydrogels.

As used herein, the term “ophthalmic device” refers to devices that reside in or on the eye. These devices can provide optical correction, wound care, drug delivery, diagnostic functionality or cosmetic enhancement or effect or a combination of these properties. Useful ophthalmic devices include, but are not limited to, ophthalmic lenses such as soft contact lenses, e.g., a soft, hydrogel lens; soft, non-hydrogel lens and the like, hard contact lenses, e.g., a hard, gas permeable lens material and the like, intraocular lenses, overlay lenses, ocular inserts, optical inserts and the like. As is understood by one skilled in the art, a lens is considered to be “soft” if it can be folded back upon itself without breaking.

The invention is applicable to a wide variety of materials, and silicone hydrogel contact lens materials are particularly preferred. Hydrogels in general are a well-known class of materials that comprise hydrated, cross-linked polymeric systems containing water in an equilibrium state. Silicone hydrogels generally have a water content greater than about 5 weight percent and more commonly between about 10 to about 80 weight percent. Such materials are usually prepared by polymerizing a mixture containing at least one silicone-containing monomer and at least one hydrophilic monomer. Typically, either the silicone-containing monomer or the hydrophilic monomer functions as a crosslinking agent (a crosslinker being defined as a monomer having multiple polymerizable functionalities) or a separate crosslinker may be employed. Applicable silicone-containing monomeric units for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Representative examples of applicable silicon-containing monomeric units include bulky polysiloxanylalkyl (meth)acrylic monomers represented by the structure of Formula I:

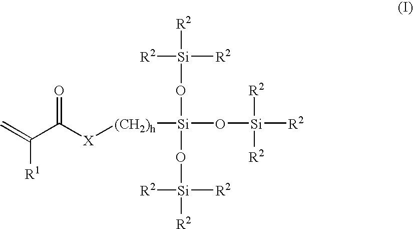

wherein X denotes —O— or —NR—; each R¹ independently denotes hydrogen or methyl; each R² independently denotes a lower alkyl radical, phenyl radical or a group represented by

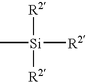

wherein each R^{2′} independently denotes a lower alkyl or phenyl radical; and h is 1 to 10.

Examples of bulky monomers are 3-methacryloyloxypropyltris(trimethyl-siloxy)silane or tris(trimethylsiloxy)silylpropyl methacrylate, sometimes referred to as TRIS and tris(trimethylsiloxy)silylpropyl vinyl carbamate, sometimes referred to as TRIS-VC and the like.

Such bulky monomers may be copolymerized with a silicone macromonomer, such as a poly(organosiloxane) capped with an unsaturated group at two or more ends of the molecule. U.S. Pat. No. 4,153,641 discloses, for example, various unsaturated groups such as acryloyloxy or methacryloyloxy groups.

Another class of representative silicone-containing monomers includes, but is not limited to, silicone-containing vinyl carbonate or vinyl carbamate monomers such as, for example, 1,3-bis[4-vinyloxycarbonyloxy)but-1-yl]tetramethyl-disiloxane; 3-(trimethylsilyl)propyl vinyl carbonate; 3-(vinyloxycarbonylthio)propyl-[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; trimethylsilylmethyl vinyl carbonate and the like and mixtures thereof.

Another class of silicon-containing monomers includes polyurethane-polysiloxane macromonomers (also sometimes referred to as prepolymers), which may have hard-soft-hard blocks like traditional urethane elastomers. They may be end-capped with a hydrophilic monomer such as 2-hydroxyethyl methacrylate (HEMA). Examples of such silicone urethanes are disclosed in a variety or publications, including PCT Published Application No. WO 96/31792 discloses examples of such monomers, which disclosure is hereby incorporated by reference in its entirety. Representative examples of silicone urethane monomers are represented by Formulae II and III:

E(*D*A*D*G)ₐ*D*A*D*E′; or (II)

E(*D*G*D*A)ₐ*D*A*D*E′; or (III)

wherein:

D independently denotes an alkyl diradical, an alkyl cycloalkyl diradical, a cycloalkyl diradical, an aryl diradical or an alkylaryl diradical having 6 to about 30 carbon atoms;

G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;
* denotes a urethane or ureido linkage;
a is at least 1;
A independently denotes a divalent polymeric radical of Formula IV:

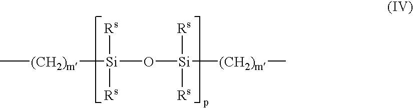

wherein each R^{s} independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;

each of E and E′ independently denotes a polymerizable unsaturated organic radical represented by Formula V:

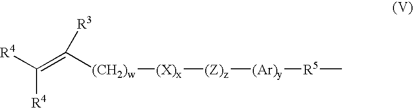

wherein: R³ is hydrogen or methyl;
R⁴ is hydrogen, an alkyl radical having 1 to 6 carbon atoms, or a —CO—Y—R radical
wherein Y is —O—, —S— or —NH—;
R⁵ is a divalent alkylene radical having 1 to about 10 carbon atoms;
R⁶ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

A preferred silicone-containing urethane monomer is represented by Formula VI:

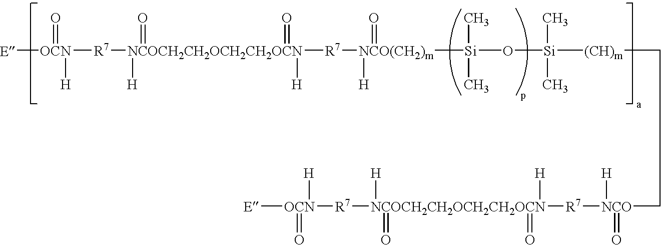

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

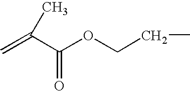

In another embodiment of the present invention, a silicone hydrogel material comprises (in bulk, that is, in the monomer mixture that is copolymerized) about 5 to about 70 percent, and preferably about 10 to about 60, by weight of one or more silicone macromonomers, about 5 to about 60 percent, and preferably about 10 to about 60 percent, by weight of one or more polysiloxanylalkyl (meth)acrylic monomers, and about 20 to about 60 percent, and preferably about 10 to about 50 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 discloses additional unsaturated groups, including acryloyloxy or methacryloyloxy groups. Fumarate-containing materials such as those disclosed in U.S. Pat. Nos. 5,310,779; 5,449,729 and 5,512,205 are also useful substrates in accordance with the invention. Preferably, the silane macromonomer is a silicon-containing vinyl carbonate or vinyl carbamate or a polyurethane-polysiloxane having one or more hard-soft-hard blocks and end-capped with a hydrophilic monomer.

In one embodiment, the lens can be a Group II and Group IV lens having a water content greater than about 50% by weight, and preferably about 55% to about 80% water, although the invention is applicable for any type of soft hydrogel contact lens. Representative contact lens materials include, but are not limited to materials known by the following USAN and the USAP Dictionary of Drug Names: bufilcon A, etafilcon A, methafilcon A, ocufilcon C, perfilcon A, phemfilcon A, vifilcon A, hilafilcon A, hilafilcon B, balafilcon A, methafilcon B, ocufilcon D, methafilcon A, etafilcon A lidofilcon A or B, and alphafilcon A.

The above materials are merely exemplary, and other materials for use as substrates and have been disclosed in various publications and are being continuously developed for use in biomedical devices such as contact lenses and other medical devices can also be used. For example, a biomedical device for use herein can be formed from at least a cationic material such as a cationic silicone-containing material. In another embodiment, a biomedical device for use herein can be formed from at least a fluorinated silicone-containing material. Such material have been used in the formation of fluorosilicone hydrogels to reduce the accumulation of deposits on contact lenses made therefrom, as disclosed in, for example, U.S. Pat. Nos. 4,954,587; 5,010,141 and 5,079,319. The use of silicone-containing monomers having certain fluorinated side groups, i.e., —(CF₂)—H, can also be used herein, such as those disclosed in, e.g., U.S. Pat. Nos. 5,321,108 and 5,387,662.

Suitable hydrophilic monomers include one or more unsaturated carboxylic acids, vinyl lactams, amides, polymerizable amines, vinyl carbonates, vinyl carbamates, oxazolone monomers, and the like and mixtures thereof. Useful amides include acrylamides such as N,N-dimethylacrylamide and N,N-dimethylmethacrylamide. Useful vinyl lactams include cyclic lactams such as N-vinyl-2-pyrrolidone. Examples of other hydrophilic monomers include poly(alkene glycols) functionalized with polymerizable groups. Examples of useful functionalized poly(alkene glycols) include poly(diethylene glycols) of varying chain length containing monomethacrylate or dimethacrylate end caps. In a preferred embodiment, the poly(alkene glycol) polymer contains at least two alkene glycol monomeric units. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art.

The monomer mixture used in forming the biomedical devices such as contact lenses can further include one or more crosslinking agents, strengthening agents, free radical initiators and/or catalysts and the like as is well known in the art.

The mold assembly for use in the method of the present invention will include at least a mateable pair of mold parts in which at least one anterior mold part is made of a first plastic material and one posterior mold part is made of a second plastic material, wherein the first plastic material is more polar relative to the second plastic material. While not wishing to be bound by any particular theory, it is believed that the more polar mold can draw the hydrophilic monomer in the monomer mixture closer to the mold surface prior to curing resulting in the lenses surface being more hydrophilic.

A suitable first plastic material for use in making the anterior mold part includes polyacrylonitriles, polyimides, polyamides, polysulfones, polyvinylidine fluorides, polyvinyl alcohols and copolymers thereof.

In one embodiment, a first plastic material of the anterior mold part is a copolymer of an α,β olefinically unsaturated mononitrile and at least one comonomer to enhance melt processability. The olefinically unsaturated mononitriles include acrylonitrile, alpha-chloroacrylonitrile, alpha-fluoroacrylonitrile, methacrylonitrile, and ethylacrylonitrile. The resin must be stable in the presence of the unpolymerized contact lens formulation. The softening temperature is preferably at least about 30° C., and more preferably at least about 50° C. to assure compatibility with cure conditions and to assure mold stability. Although the mold formed from the resin may be opaque, the ultraviolet transmission is preferably at least about 10% to facilitate efficient ultraviolet curing of the contact lens material.

Homopolymers of α,β olefinically unsaturated mononitriles have limited application in melt processing (required for production of molds) because of high melting point, poor thermal stability, and high melt viscosity. A wide variety of monomers which may be copolymerized with the mononitrile to produce resins useful for melt processing are well known in the art. For example, suitable comonomers to copolymerize with the alpha, beta olefinically unsaturated mononitriles include styrenic monomers, benzofuran, esters of (meth)acrylic acid, and vinylic monomers. Examples of suitable styrenic monomers are styrene, alpha-methyl styrene, para-methyl styrene, para-t-butyl styrene, para-t-butyl monochloro styrene, and para-t-butyl dichloro styrene. Examples of suitable esters of (meth)acrylic acid are methyl acrylate, methyl methacrylate, and 2-dimethylaminoethyl methacrylate. Examples of suitable vinylic monomers are vinyl acetate, 4-vinylpyridine, and vinylidene chloride. More detailed descriptions of these copolymers, their preparation, and their properties may be found in Peng, F., “Acrylonitrile Polymers,” Encyclopedia of Polymer Science and Engineering, 2d Ed., Vol. 1, pp. 426-470 (John Wiley & Sons, N.Y., N.Y.)(1985).

The comonomers may be modified with an elastomer, desirably a copolymer of a conjugated diene and an alpha, beta olefinically unsaturated mononitrile. Particularly preferred dienes are butadiene and isoprene. Other elastomers such as acrylic elastomers, ethylenepropylene rubbers, and urethane elastomers may also be employed. The only requirement of the elastomer is that it be compatible with the mononitrile.

A class of useful elastomer-modified mononitrile copolymers is ABS, the two-phase system resulting when styrene-acrylonitrile grafted rubber is blended with styrene-acrylonitrile copolymers.

In one preferred embodiment, the first plastic material is prepared by polymerizing an olefinic nitrite (especially acrylonitrile) with an olefinic ester (especially methyl acrylate) in an aqueous medium in the presence of a nitrile rubber. Such resins are described in U.S. Pat. No. 3,426,102 and are available from British Petroleum under the trademark “Barex”. Generally, a Barex resin is a rubber modified copolymer containing about 75% acrylonitrile and about 25% methyl acrylate.

In one embodiment, the first plastic material is a polyimide such as a polyetherimide or a copolymer thereof. Such resins are commercially available from General Electric under the trademark “Ultem”.

In yet another embodiment, the first plastic material is a polyvinyl alcohol or a copolymer thereof such as an ethylene vinyl alcohol copolymer.

The second plastic material for use in making the posterior mold part can be any of the materials listed above for the first plastic material as long as the first plastic material is more polar relative to the second plastic material. Alternatively, the second plastic material can be polymers and copolymers which contain predominantly polyolefins or co-polymers, or blends of such materials. Useful polyolefins include polyethylene, polypropylene, polystyrene and the like and mixtures thereof. Polypropylene is the most preferred second plastic mold material.

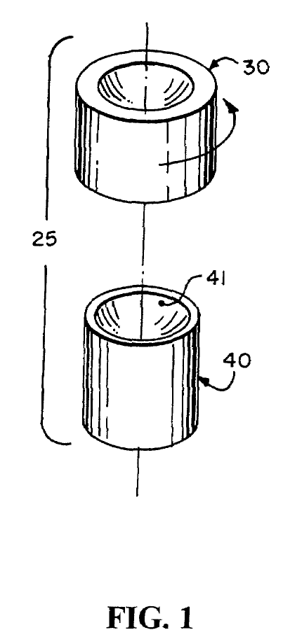

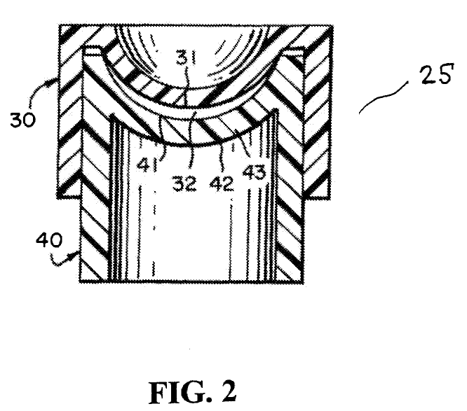

A representative example of a mold assembly of this invention is generally depicted as mold assembly 25 in FIGS. 1 and 2. In general, the mold assembly includes posterior mold 30 having a posterior mold cavity defining surface 31 (which forms the posterior surface of the molded lens), and anterior mold 40 having an anterior mold cavity defining surface 41 (which forms the anterior surface of the molded lens). When the mold sections are assembled, a mold cavity 32 is formed between the two defining surfaces that correspond to the desired shape of the contact lens molded therein. As seen in the Figures, anterior mold section 40 includes surface 42 opposed to anterior mold cavity defining surface 41, surfaces 41 and 42 defining segment 43 there between of mold section 40. Opposed surface 42 of contact lens mold 40 does not contact the polymerizable lens mixture in casting contact lenses, i.e., opposed surface 42 does not form part of mold cavity 32.

The method of polymerization or cure is not critical to the practice of this invention, except that this invention is particularly suitable to free radical polymerization systems as are well known in the contact lens art. Thus, the polymerization can occur by a variety of mechanisms depending on the specific composition employed. For example, thermal, photo, X-ray, microwave, and combinations thereof which are free radical polymerization techniques can be employed herein. Preferably, thermal and photo polymerizations are used in this invention with UV polymerization being most preferred.

Typically, an organic diluent is included in the initial monomeric mixture in order to minimize phase separation of polymerized products produced by polymerization of the monomeric mixture and to lower the glass transition temperature of the reacting polymeric mixture, which allows for a more efficient curing process and ultimately results in a more uniformly polymerized product. Sufficient uniformity of the initial monomeric mixture and the polymerized product is of particular importance for silicone hydrogels, primarily due to the inclusion of silicone-containing monomers which may tend to separate from the hydrophilic comonomer.

Suitable organic diluents include, for example, monohydric alcohols such as C₆-C₁₀ straight-chained aliphatic monohydric alcohols, e.g., n-hexanol and n-nonanol; diols such as ethylene glycol; polyols such as glycerin; ethers such as diethylene glycol monoethyl ether; ketones such as methyl ethyl ketone; esters such as methyl enanthate; and hydrocarbons such as toluene. Preferably, the organic diluent is sufficiently volatile to facilitate its removal from a cured article by evaporation at or near ambient pressure. Generally, the diluent may be included at about 5 to about 60 percent by weight of the monomeric mixture, with about 10 to about 50 percent by weight being preferred. If necessary, the cured lens may be subjected to solvent removal, which can be accomplished by evaporation at or near ambient pressure or under vacuum. An elevated temperature can be employed to shorten the time necessary to evaporate the diluent.

Following removal of the organic diluent, the lens can then be subjected to mold release and optional machining operations. The machining step includes, for example, buffing or polishing a lens edge and/or surface. Generally, such machining processes may be performed before or after the article is released from a mold part. As an example, the lens can be dry released from the mold. Alternatively, the lens can be wet released from the mold with an organic solvent, or mixture of solvent and water.

Next, the device is subjected to a surface treatment in accordance with the present invention. In general, the foregoing biomedical devices such as wettable silicone-based hydrogel lenses are contacted with a solution containing at least a proton-donating wetting agent, whereby the wetting agent forms a complex with the hydrophilic monomer on the surface of the biomedical device. The biomedical devices can either be contacted with the solution containing at least a proton-donating wetting agent directly in the mold assembly or the biomedical device can be released from the mold assembly and then contacted with the solution. The solutions are typically water-based solutions containing the proton-donating wetting agent and render a lubricious, stable, highly wettable surface such as a carboxylic acid-containing, sulfonic acid-containing, phosphoric acid-containing polymeric or copolymeric based surface coating. The complexation treatment is advantageously performed under autoclave conditions.

The proton-donating wetting agent includes any suitable carboxylic acid, sulfonic acid, or phosphoric acid-containing polymer or copolymer. Suitable carboxylic acid-containing polymer or copolymers include, but are not limited to, poly(vinylpyrrolidinone(VP)-co-acrylic acid(AA)), poly(methylvinylether-alt-maleic acid), poly(acrylic acid-graft-ethylene oxide), poly(acrylic acid-co-methacrylic acid), poly(acrylamide-co-AA), poly(AA-co-maleic acid), poly(p-vinylphenylsulfonic acid), poly(butadiene-maleic acid) and mixtures thereof. In one embodiment, suitable carboxylic acid-containing polymers or copolymers are characterized by carboxylic acid contents of at least about 30 mole percent and preferably at least about 40 mole percent.

Solvents useful in the surface treatment (contacting) step of the present invention include solvents that readily solubilize proton donating solutes such as carboxylic acids, sulfonic acids, fumaric acid, maleic acid, anhydrides such as maleic anhydride and functionalized alcohols. Preferred solvents include tetrahydrofuran (THF), acetonitrile, N,N-dimethyl formamide (DMF), and water. The most preferred solvent is water.

The surface treatment solution is preferably acidified before the contact step. The pH of the solution is suitably less than about 7, preferably less than about 5 and more preferably less than about 4. In a particularly preferred embodiment, the pH of the solution is about 3.5. For a discussion of the theory underlying the role of pH in complexation reactions in general, see Advances in Polymer Science, published by Springer-Verlag, Editor H. J. Cantow, et al, V45, 1982, pages 17-63.

The following examples are provided to enable one skilled in the art to practice the invention and are merely illustrative of the invention. The examples should not be read as limiting the scope of the invention as defined in the claims.

In the examples, the following abbreviations are used.

IDS3H: A prepolymer derived from 4 moles of isophorone diisocyanate, 2 moles of diethylene glycol, one mole of hydroxybutyl-terminated polydimethylsiloxane of Mₙ 3000 and end-capped with 2-hydroxyethyl methacrylate

14D5S4H: A prepolymer derived from 10 moles of isophorone diisocyanate, 4 moles of diethylene glycol, 5 moles of hydroxybutyl-terminated polydimethylsiloxane of Mₙ 4000 and end-capped with 2-hydroxyethyl methacrylate

TRIS: tris(trimethylsiloxy)silylpropyl methacrylate

NVP: N-vinyl-2-pyrrolidone

DMA: N,N-dimethyl acrylamide

VDMO: vinyldimethyloxazolone

HEMA: 2-hydroxyethyl methacrylate

HEMAVC: methacryloxyethyl vinyl carbonate

D1173: 2-hydroxy-2-methyl-1-phenylpropan-1-one (available as Darocur 1173 initiator)

IMVT: 1,4-bis(4-(2-methacryloxyethyl)phenylamino)anthraquinone

### EXAMPLE 1

Preparation of a polyurethane-siloxane-based silicone hydrogel lens.

A monomer mix was made by mixing the following components, listed in Table 1 at amounts per weight. The prepolymer IDS3H can be prepared as disclosed in U.S. Pat. No. 5,034,461.

TABLE 1

| Ingredient | Amount |
|---|---|
| IDS3H | 30 |
| TRIS | 30 |
| NVP | 27 |
| DMA | 9 |
| VDMO | 1 |
| HEMAVC | 0.5 |
| Hexanol | 40 |
| Darocur-1173 | 0.5 |

The resultant monomer mixture was cast into contact lenses by introducing the monomer mixture to a mold assembly composed of a Barex mold for the anterior surface and a polypropylene (“PP”) mold for the posterior surface. Then, the mold assembly and monomer mixture were exposed to ultraviolet light to induce free radical polymerization and cure the monomer mixture to form a contact lens. The resultant contact lenses were released from the mold assembly, extracted with isopropanol and dried.

### EXAMPLE 2

Preparation of a polyurethane-siloxane-based silicone hydrogel lens.

A monomer mix was made by mixing the following components, listed in Table 2 at amounts per weight.

TABLE 2

| Ingredient | Amount |
|---|---|
| IDS3H | 25 |
| TRIS | 25 |
| NVP | 35 |
| DMA | 15 |
| HEMAVC | 0.5 |
| Hexanol | 40 |
| Darocur-1173 | 0.5 |

The resultant monomer mixture was cast into contact lenses by introducing the monomer mixture to a mold assembly composed of a Barex mold for the anterior surface and a PP mold for the posterior surface. Then, the mold assembly and monomer mixture were exposed to ultraviolet light to induce free radical polymerization and cure the monomer mixture to form a contact lens. The resultant contact lenses were released from the mold assembly, extracted with isopropanol and dried.

### EXAMPLE 3

Lens surface characterization by XPS.

The lenses cast in Examples 1 and 2 were characterized by XPS.

### XPS Analysis

The lenses of Examples 1 and 2 were analyzed for their atomic concentration by X-ray Photoelectron Spectrometer (XPS). The XPS utilized in this study was a Physical Electronics [PHI] Model 5600. This instrument utilized an aluminum anode operated at 300 watts, 15 kV and 27 milliamps. The excitation source was monochromatized utilizing a torodial lens system. The 7 mm filament was utilized for the polymer analysis due to the reduced sample damage and ease of photoionization neutralization. The base pressure of this instrument was 2.0×10⁻¹⁰ torr while the pressure during operation was 1.0×10⁻⁹ torr. This instrument made use of a hemispherical energy analyzer. The practical measure of sampling depth for this instrument at a sampling angle of 45° and with respect to carbon was approximately 74 angstroms. All elements were charge corrected to the CHₓ peak of carbon to a binding energy of 285.0 electron volts (eV).

Each of the specimens was analyzed utilizing a low resolution survey spectra [0-1100 eV] to identify the elements present on the sample surface. The high resolution spectra were performed on those elements detected from the low resolution scans. The elemental composition was determined from the high resolution spectra. The atomic composition was calculated from the areas under the photoelectron peaks after sensitizing those areas with the instrumental transmission function and atomic cross sections for the orbital of interest. Since XPS does not detect the presence of hydrogen or helium, these elements will not be included in any calculation of atomic percentages.

The data reflects the atomic composition over the top 74 angstroms (relative to carbon 1 s electrons). The XPS results for the lenses of Examples 1 and 2 are set forth below in Table 3.

TABLE 3

Atomic
Concentration

| | N | Si |
|---|---|---|
| Example 1 (anterior surface) | 4.8 | 11.3 |
| Example 1 (posterior surface) | 3.3 | 13.8 |
| Example 2 (anterior surface) | 6.1 | 9.1 |
| Example 2 (posterior surface) | 3.9 | 13.6 |

As the data show, the anterior surface had more nitrogen content and less Si content than that of the posterior surface which was cast against the less polar PP mold. This indicates that the anterior lens surface was more polar than the surface of the posterior lens surface. Also, since the nitrogen atom came mostly from the NVP hydrophilic monomer, it indicated that the more polar mold can draw more hydrophilic monomer onto the lens surface and provide a surface rich in hydrophilic monomer. This is believed to allow for an easier and effective complexation of a hydrophilic monomer such as NVP with an acid-containing polymer in the treating polymer solution than when a monomer mix is cast against polypropylene which provides a surface having less hydrophilic monomer as shown in the lower nitrogen content. This is also true for silicone hydrogels of lower and higher water content as reflected in the lenses cast in Example 1 and 2, which were derived from formulations containing different amount of hydrophilic monomers.

### EXAMPLE 4

Preparation of a polyurethane-siloxane hydrogel lens.

A monomer mix was made by mixing the following components, listed in Table 4 at amounts per weight. The prepolymer 14D5S4H can be prepared as disclosed in U.S. Patent Application Publication No. 20060142525.

TABLE 4

| Ingredient | Amount |
|---|---|
| I4D5S4H | 53 |
| TRIS | 15 |
| NVP | 24 |
| DMA | 9 |
| HEMA | 5 |
| HEMAVC | 1 |
| n-hexanol | 10 |
| Darocur-1173 | 0.5 |
| IMVT | 150 ppm |

The resultant monomer mixture was cast into contact lenses by introducing the monomer mixture to a mold assembly composed of a Barex mold for the anterior surface and a PP mold for the posterior surface. Next, the mold assembly and monomer mixture were exposed to ultraviolet light to induce free radical polymerization and cure the monomer mixture to form a contact lens. The resultant contact lenses were released from the mold assembly, extracted with isopropanol overnight and placed in de-inionized water.

### EXAMPLE 5

Surface treatment with a copolymer containing an acid solution.

An aqueous solution containing 3% copolymer of acrylic acid/glyceryl methacrylate (1:4 weight ratio) in water is prepared. The lenses of Examples 4 are placed in vials containing the aqueous acid solution and autoclaved for 1 cycle. The treated lenses are then placed in a borate buffered saline and autoclaved.

### EXAMPLE 6

Surface treatment with a polyacrylic acid solution.

An aqueous solution containing 3% of polyacrylic acid in water is prepared. The lenses of Example 4 are placed in vials containing the aqueous acid solution and autoclaved for 1 cycle. The treated lenses are then placed in a borate buffered saline and autoclaved.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A method of preparing a biomedical device for use in or on the eye, the method comprising the steps: (a) cast molding at least one biomedical device formed from a monomer mixture comprising at least one silicone-containing monomer and at least one hydrophilic monomer in a mold assembly, the mold assembly comprising at least one anterior mold part made of a first plastic material and one posterior mold part made of a second plastic material, wherein the first plastic material is more polar relative to the second plastic material; and (b) contacting a surface of the biomedical device with a solution comprising a proton-donating wetting agent, whereby the wetting agent forms a complex with the hydrophilic monomer on the surface of the biomedical device.

2. The method of claim 1, wherein the first plastic material comprises a polyacrylonitrile, polyimide, polyamide, polysulfone, polyvinylidine fluoride, polyvinyl alcohol or a copolymer thereof.

3. The method of claim 1, wherein the first plastic material comprises one or more moieties selected from the group consisting of nitrile, imide, alcohol, acid, fluoride and sulfone groups.

4. The method of claim 1, wherein the first plastic material comprises a polyacrylonitrile, polyimide, polyamide, polysulfone, polyvinylidine fluoride, polyvinyl alcohol or a copolymer thereof and the second plastic material comprises a polyacrylonitrile, polyimide, polyamide, polysulfone, polyvinylidine fluoride, polyvinyl alcohol or a copolymer thereof.

5. The method of claim 1, wherein the second plastic material is a polyolefin.

6. The method of claim 5, wherein the polyolefin is polypropylene.

7. The method of claim 1, wherein the first plastic material comprises a polyacrylonitrile, polyimide, polyamide, polysulfone, polyvinylidine fluoride, polyvinyl alcohol or copolymer thereof and the second plastic material is a polyolefin.

8. The method of claim 1, wherein the first plastic material is a copolymer of butyl acrylate and acrylonitrile and the second plastic material is polypropylene.

9. The method of claim 1, wherein the monomer mixture comprises about 5 to about 70 percent by weight of one or more silicone macromonomers and about 10 to about 50 percent by weight of the hydrophilic monomer.

10. The method of claim 1, wherein the hydrophilic monomer is selected from the group consisting of an unsaturated carboxylic acid, vinyl lactam, acrylamide, polymerizable amine, vinyl carbonate, vinyl carbamate, oxazolone monomer and mixtures thereof.

11. The method of claim 1, wherein the hydrophilic monomer is selected from the group consisting of methacrylic and acrylic acids, 2-hydroxyethylmethacrylate, N-vinylpyrrolidone, methacrylamide, N,N-dimethylacrylamide and mixtures thereof.

12. The method of claim 1, wherein step (b) comprises removing the biomedical device from the mold assembly and contacting a surface of the biomedical device with a solution comprising a proton-donating wetting agent.

13. The method of claim 1, wherein step (b) comprises contacting the surface of the biomedical device with the solution in the mold assembly and removing the biomedical device from the mold assembly.

14. The method of claim 1, wherein the proton-donating wetting agent is a carboxylic acid-, sulfonic acid-, or a phosphoric acid-containing polymer or copolymer.

15. The method of claim 14, wherein the carboxylic acid-containing polymer or copolymer in the solution is characterized by an acid content of at least about 40 mole percent.

16. The method of claim 1, wherein the proton-donating wetting agent is a polyacrylic acid.

17. The method of claim 1, wherein the proton-donating wetting agent is a copolymer of acrylic acid and glyceryl methacrylate.

18. The method of claim 1, wherein the proton-donating wetting agent is a copolymer of acrylic acid and N-vinylpyrrolidone.

19. The method of claim 1, wherein the proton-donating wetting agent is selected from the group consisting of P(vinylpyrolidinone(VP)-co-acrylic acid(AA)), P(methylvinylether-alt-maleic acid), P(acrylic acid-graft-ethyleneoxide), P(acrylic acid-co-methacrylic acid), P(acrylamide-co-AA), P(acrylamide-co-AA), P(AA-co-maleic), P(para-vinylphenylsulfonic acid), P(butadiene-maleic acid) and mixtures thereof.

20. The method of claim 1, wherein the biomedical device is an ophthalmic lens.

21. The method of claim 20, wherein the ophthalmic lens is a contact lens.

22. The method of claim 21, wherein the contact lens is a silicone hydrogel lens.

23. A method for improving the wettability of a biomedical device, the method comprising the steps of: (a) cast molding at least one biomedical device formed from a monomer mixture comprising at least one silicone-containing monomer and at least one hydrophilic monomer in a mold assembly, the mold assembly comprising at least one anterior mold part made of a first plastic material and one posterior mold part made of a second plastic material, wherein the first plastic material is more polar relative to the second plastic material; and (b) contacting a surface of the biomedical device with a solution comprising a proton-donating wetting agent, whereby the wetting agent forms a complex with the hydrophilic monomer on the surface of the biomedical device.

24. The method of claim 23, wherein the first plastic material comprises a polyacrylonitrile, polyimide, polyamide, polysulfone, polyvinylidine fluoride, polyvinyl alcohol or a copolymer thereof and the second plastic material comprises a polyolefin, polyacrylonitrile, polyimide, polyamide, polysulfone, polyvinylidine fluoride, polyvinyl alcohol or a copolymer thereof.

25. The method of claim 23, wherein the proton-donating wetting agent is selected from the group consisting of P(vinylpyrolidinone(VP)-co-acrylic acid(AA)), P(methylvinylether-alt-maleic acid), P(acrylic acid-graft-ethyleneoxide), P(acrylic acid-co-methacrylic acid), P(acrylamide-co-AA), P(acrylamide-co-AA), P(AA-co-maleic), P(para-vinylphenylsulfonic acid), P(butadiene-maleic acid) and mixtures thereof.
